(19) United States
(12) Patent Application Publication
(10) Pub. No.: US 2021/0398197 A1
(43) Pub. Date: Dec. 23, 2021

(54) METHOD AND APPARATUS FOR IDENTIFYING A SELECTED PRODUCT BASED ON LOCATION

(71) Applicant: HERE Global B.V., Eindhoven (NL)

(72) Inventors: Henri Jaakko Julius NURMINEN, Tampere (FI); Pavel IVANOV, Tampere (FI); Lauri Aarne Johannes WIROLA, Tampere (FI)

(73) Assignee: HERE Global B.V., Eindhoven (NL)

(21) Appl. No.: 17/116,855

(22) Filed: Dec. 9, 2020

Related U.S. Application Data
(60) Provisional application No. 63/042,241, filed on Jun. 22, 2020.

(51) Int. Cl. G06Q 30/06; H04W 4/029; G06Q 20/20; G06Q 10/08

(52) U.S. Cl. CPC G06Q 30/0639; H04W 4/029; G06Q 30/0623; G06Q 10/087; G06Q 20/208

(57) ABSTRACT

A method, apparatus and computer program product are provided to identify a selected product based on location. In the context of a method, a comparison is performed, for each of a plurality of products, of one or more locations of a shopper relative to a location of a respective product. For each of the plurality of products, the method also includes determining, based upon the comparison of the one or more locations of the shopper relative to the location of the respective product, a likelihood that the respective product was manually selected. Based on the likelihoods that respective products were manually selected, the method further includes identifying one or more of the plurality of products.

### CROSS REFERENCE TO RELATED APPLICATION

This application claims benefit of U.S. Provisional Application No. 63/042,241, filed Jun. 22, 2020, which is incorporated herein by reference in its entirety.

### TECHNOLOGICAL FIELD

An example embodiment relates generally to the identification of a selected product and, more particularly, to the identification of a selected product based upon location.

### BACKGROUND

While shopping, shoppers may select one or more products for subsequent purchase. In order to properly price the products, the products must be identified. In many instances, the products are packaged, labelled, or otherwise tagged in such a manner as to permit the product to be identified based upon the packaging, label or tag. For example, the packaging, label or tag may include a bar code, a quick response (QR) code, or other indicia identifying the product such that by scanning the bar code or the QR code or by reading the other indicia identifying the product, the product is identified. With respect to some products, however, the products are not packaged, labelled or tagged in such a manner as to provide information identifying the product such that the product must be identified in a different manner. In addition to identifying these products, the quantity or amount of the product must also generally be determined since the price to be paid for the product is frequently based upon the quantity or amount of the product.

By way of example, produce, such as fruits and vegetables, are frequently displayed in a grocery store in bulk without any packaging. For example, the produce section of a grocery store may include one container that includes a plurality of tomatoes, a second container that includes a plurality of cucumbers, a third container that includes a plurality of apples, etc. A shopper then selects a desired quantity of certain fruits and vegetables. For example, a shopped may select three tomatoes and four apples, but no cucumbers. The price to be paid for the fruits and vegetables is dependent upon the type of fruits and vegetables that have been selected and is frequently further based upon the weight of the fruits and vegetables that are selected. Thus, the shopper may place each different type of fruit or vegetable that has been selected upon a scale in order to determine the weight of the respective fruits or vegetables. Based upon the identity of a respective fruit or vegetable and the weight or quantity of the respective fruit or vegetable, the price to be paid by the shopper may then defined.

As a result of the wide variety of potential fruits and vegetables from which the shopper makes a selection and depending upon the number of different fruits and vegetables that are selected by a shopper, the process by which the fruits and vegetables are identified, such as an advance of determining the weight of a respective fruit or vegetable, may be time consuming, may require the shopper to expand considerable effort and/or may require the store to employ additional personnel to assist in the process. A fruit or vegetable may be identified in various manners. In one technique, indicia in the form of an identifier, such as a numerical code, is associated with the fruit or vegetable. For example, a sticker may be placed on the fruit or vegetable that includes the identifier and/or the container from which the fruit or vegetable was selected may be labeled with the identifier. In order to weigh a fruit or vegetable and to determine the price to paid for the fruit or vegetable, the shopper may interact with a terminal associated with a scale upon which the fruit or vegetable will be weighed. The shopper may enter the identifier, such as via a user interface of the terminal, such that the price of the fruit or vegetable may then be determined based upon the weight of the identified fruit or vegetable. However, this technique requires the shopper to locate and remember the identifier associated with the fruit or vegetable and to correctly enter the identifier via the user interface of the terminal, thereby creating a relatively involved process, particularly for a shopper having many different types of fruits and vegetables, that is susceptible to mistakes in the identification of the product created by human error in the entry of the identifier.

Instead of requiring an identifier in the form of a numerical code to be entered, the user interface may include keys that identify the various fruits or vegetables, such as by name or with an image of a respective fruit or vegetable. In instances in which a relatively large number of different types of fruits and vegetables must be separately identified, the user interface may have a hierarchical menu structure in which the fruits or vegetables are initially separated into groups of similar fruits or vegetables prior to allowing selection of the specific fruit or vegetable from the selected group. For example, in order identify a Gala apple, a shopper may initially select a key from the user interface identifying the category of fruits. The user interface may then display a second hierarchical level of the menu structure with keys associated with the different types of fruits from which the shopper may select the key associated with apples. Thereafter, the user interface may display a third hierarchical level of the menu structure with keys associated with different varieties of apples. The shopper can then select the key associated with Gala apples and the apples can be weighed and priced. While avoiding issues associated with the memorization and entry of an identifier in the form a numerical code, a user interface that employs a hierarchical menu structure may require additional time to navigate and is dependent upon the shopper knowing the particular category and type of fruit or vegetable to be identified.

Still further, a store may assign a staff member to identify and weigh the products selected by a shopper. While this approach reduces the burden upon the shopper, the associated costs for the store are generally increased. Thus, while the products selected by a shopper can be identified and weighed in a variety of different manners, each approach is challenged, for example, by increases in the effort to be expended by the shopper, the complexity of the user interface and/or the cost incurred by the store.

### BRIEF SUMMARY

A method, apparatus and computer program product are provided in accordance with an example embodiment in order to identify a selected product based on location. In this regard, a selected product, including products that are loosely displayed in bulk for individual selected by a shopper, may be identified based on location(s) of the shopper relative to the location of a respective product. As a result, one or more products that are most likely to have been selected by a shopper may be identified, such as in automated manner. Thus, the method, apparatus and computer program product of an example embodiment identify a selected product in a manner that is not only accurate, but also efficient. Consequently, the effort expended by a shopper and/or the store to identify a selected product may be reduced with the shopper interacting with a user interface that is both intuitive and accurate with the respect to the identification of the selected product.

In an example embodiment, a method is provided for identifying a selected product based on location. For each of a plurality of products, the method includes performing a comparison of one or more locations of a shopper relative to a location of a respective product. For each of the plurality of products, the method also includes determining, based upon the comparison of the one or more locations of the shopper relative to the location of the respective product, a likelihood that the respective product was manually selected. Based on the likelihoods that respective products were manually selected, the method further includes identifying one or more of the plurality of products.

The method of an example embodiment determines the likelihood by determining the likelihood that the respective product was manually selected based also upon a time at which the location of the shopper was proximate the respective product. In this example embodiment, the method may also determine the likelihood by determining the likelihood that the respective product was manually selected based upon a difference between the time at which the location of the shopper was proximate the respective product and a time at which the shopper is proximate a terminal at which the respective product is to be identified. The terminal may comprise or be associated with scales configured to weigh the respective product. In this example embodiment, the method may also determine the likelihood by also evaluating a probability function having an inverse relationship to the difference between the time at which the location of the shopper was proximate the respective product and the time at which the shopper is proximate the terminal at which the respective product is to be identified.

The method of an example embodiment performs the comparison by determining, for each of the plurality of products, a minimum distance between the one or more locations of the shopper and the location of the respective product. In this example embodiment, the method also includes, for each of the plurality of products, determining a time at which the shopper was located at the minimum distance from the location of the respective product. Also in accordance with this example embodiment, the method determines the likelihood by determining the likelihood that the respective product was manually selected based upon the difference between the time at which the location of the shopper was located at the minimum distance from the location of the respective product and the time at which the shopper is proximate the terminal at which the respective product is to be identified.

The method of an example embodiment determines the likelihood by modifying the likelihood in a manner that is dependent upon a speed at which the shopper is walking proximate the location of the respective product. In an example embodiment, the method determines the likelihood by modifying the likelihood in a manner that is dependent upon an amount of time expended by the shopper proximate the location of the respective product. The method of an example embodiment also includes determining the one or more locations of the shopper utilizing an indoor positioning technique. The method of an example embodiment also includes causing presentation of information regarding the one or more of the products that were identified to facilitate selection by the shopper. For example, the method may include causing information regarding the one or more of the products that were identified to be displayed upon a terminal that comprises or is associated with scales configured to weigh the respective product. In this example embodiment, the method further includes sorting the plurality of products based upon the likelihoods that respective products were manually selected. The method of this example embodiment also causes presentation of information regarding the one or more of the products by causing presentation of information regarded two or more of the plurality of products with the information ordered pursuant to the sorting.

The shopper may be associated with one or more additional shoppers. In this example embodiment, the method performs the comparison by performing, for each of the plurality of products and for each of the shoppers, the comparison of one or more locations of a respective shopper relative to the location of the respective product. The method of this example embodiment also determines the likelihood by determining, for each of the plurality of products, the likelihood that the respective product was selected by any one of the shoppers based upon the comparison of the one or more locations of the respective shoppers relative to the location of the respective product.

In another example embodiment, an apparatus is provided that is configured to identify a selected product based on location. The apparatus includes processing circuitry and at least one memory storing computer program code with the at least one memory and the computer program code configured to, with the processing circuitry, cause the apparatus to perform, for each of a plurality of products, a comparison of one or more locations of a shopper relative to a location of a respective product. For each of the plurality of products, the at least one memory and the computer program code are also configured to, with the processing circuitry, cause the apparatus to determine, based upon the comparison of the one or more locations of the shopper relative to the location of the respective product, a likelihood that the respective product was manually selected. Based on the likelihoods that respective products were manually selected, the at least one memory and the computer program code are further configured to, with the processing circuitry, cause the apparatus to identify one or more of the plurality of products.

The at least one memory and the computer program code are configured to, with the processing circuitry, cause the apparatus of an example embodiment to determine the likelihood by determining the likelihood that the respective product was manually selected based also upon a time at which the location of the shopper was proximate the respective product. In this example embodiment, the at least one memory and the computer program code are also configured to, with the processing circuitry, cause the apparatus of this example embodiment to determine the likelihood by determining the likelihood that the respective product was manually selected based upon a difference between the time at which the location of the shopper was proximate the respective product and a time at which the shopper is proximate a terminal at which the respective product is to be identified. The terminal may comprise or be associated with scales configured to weigh the respective product. In this example embodiment, the at least one memory and the computer program code configured to, with the processing circuitry, cause the apparatus of this example embodiment to determine the likelihood by also evaluating a probability function having an inverse relationship to the difference between the time at which the location of the shopper was proximate the respective product and the time at which the shopper is proximate the terminal at which the respective product is to be identified.

The at least one memory and the computer program code are configured to, with the processing circuitry, cause the apparatus of an example embodiment to perform the comparison by determining, for each of the plurality of products, a minimum distance between the one or more locations of the shopper and the location of the respective product. In this example embodiment, the at least one memory and the computer program code are also configured to, with the processing circuitry, cause the apparatus to determine, for each of the plurality of products, a time at which the shopper was located at the minimum distance from the location of the respective product. Also in accordance with this example embodiment, the at least one memory and the computer program code are configured to, with the processing circuitry, cause the apparatus to determine the likelihood by determining the likelihood that the respective product was manually selected based upon the difference between the time at which the location of the shopper was located at the minimum distance from the location of the respective product and the time at which the shopper is proximate the terminal at which the respective product is to be identified.

The at least one memory and the computer program code are also configured to, with the processing circuitry, cause the apparatus of an example embodiment to determine the likelihood by modifying the likelihood in a manner that is dependent upon a speed at which the shopper is walking proximate the location of the respective product. In an example embodiment, the at least one memory and the computer program code are configured to, with the processing circuitry, cause the apparatus to determine the likelihood by modifying the likelihood in a manner that is dependent upon an amount of time expended by the shopper proximate the location of the respective product. The at least one memory and the computer program code are configured to, with the processing circuitry, cause the apparatus of an example embodiment to also determine the one or more locations of the shopper utilizing an indoor positioning technique. The at least one memory and the computer program code are configured to, with the processing circuitry, cause the apparatus of an example embodiment to also cause presentation of information regarding the one or more of the products that were identified to facilitate selection by the shopper, such as by causing information regarding the one or more of the products that were identified to be displayed upon a terminal that comprises or is associated with scales configured to weigh the respective product. In this example embodiment, the at least one memory and the computer program code are further configured to, with the processing circuitry, cause the apparatus to sort the plurality of products based upon the likelihoods that respective products were manually selected. The at least one memory and the computer program code are also configured to, with the processing circuitry, cause the apparatus of this example embodiment to cause presentation of information regarding the one or more of the products by causing presentation of information regarded two or more of the plurality of products with the information ordered pursuant to the sorting.

The shopper may be associated with one or more additional shoppers. In this example embodiment, the at least one memory and the computer program code are configured to, with the processing circuitry, cause the apparatus to perform the comparison by performing, for each of the plurality of products and for each of the shoppers, the comparison of one or more locations of a respective shopper relative to the location of the respective product. The at least one memory and the computer program code are also configured to, with the processing circuitry, cause the apparatus of this example embodiment to determine the likelihood by determining, for each of the plurality of products, the likelihood that the respective product was selected by any one of the shoppers based upon the comparison of the one or more locations of the respective shoppers relative to the location of the respective product.

In a further example embodiment, a computer program product is provided that is configured to identify a selected product based on location. The computer program product includes at least one non-transitory computer-readable storage medium having computer-executable program code instructions stored therein with the computer-executable program code instructions including program code instructions configured to, when executed by an apparatus, cause the apparatus to perform, for each of a plurality of products, a comparison of one or more locations of a shopper relative to a location of a respective product. For each of the plurality of products, the computer-executable program code instructions also include program code instructions configured to determine, based upon the comparison of the one or more locations of the shopper relative to the location of the respective product, a likelihood that the respective product was manually selected. Based on the likelihoods that respective products were manually selected, the computer-executable program code instructions further include program code instructions configured to identify one or more of the plurality of products.

The program code instructions of an example embodiment that are configured to determine the likelihood include program code instructions configured to determine the likelihood that the respective product was manually selected based also upon a time at which the location of the shopper was proximate the respective product. In this example embodiment, the program code instructions configured to determine the likelihood may also include program code instructions configured to determine the likelihood that the respective product was manually selected based upon a difference between the time at which the location of the shopper was proximate the respective product and a time at which the shopper is proximate a terminal at which the respective product is to be identified. The terminal may comprise or be associated with scales configured to weigh the respective product. In this example embodiment, the program code instructions configured to determine the likelihood may also include program code instructions configured to evaluate a probability function having an inverse relationship to the difference between the time at which the location of the shopper was proximate the respective product and the time at which the shopper is proximate the terminal at which the respective product is to be identified.

The program code instructions configured to perform the comparison in accordance with an example embodiment include program code instructions configured to determine, for each of the plurality of products, a minimum distance between the one or more locations of the shopper and the location of the respective product. In this example embodiment, the program code instructions are also configured, for each of the plurality of products, to determine a time at which the shopper was located at the minimum distance from the location of the respective product. Also in accordance with this example embodiment, the program code instructions configured to determine the likelihood include program code instructions configured to determine the likelihood that the respective product was manually selected based upon the difference between the time at which the location of the shopper was located at the minimum distance from the location of the respective product and the time at which the shopper is proximate the terminal at which the respective product is to be identified.

The program code instructions of an example embodiment that are configured to determine the likelihood include program code instructions configured to modify the likelihood in a manner that is dependent upon a speed at which the shopper is walking proximate the location of the respective product. In an example embodiment, the program code instructions configured to determine the likelihood include program code instructions configured to modify the likelihood in a manner that is dependent upon an amount of time expended by the shopper proximate the location of the respective product. The computer-executable program code instructions of an example embodiment also include program code instructions configured to determine the one or more locations of the shopper utilizing an indoor positioning technique. The computer-executable program code instructions of an example embodiment also include program code instructions configured to cause presentation of information regarding the one or more of the products that were identified to facilitate selection by the shopper, such as by causing information regarding the one or more of the products that were identified to be displayed upon a terminal that comprises or is associated with scales configured to weigh the respective product. In this example embodiment, the computer-executable program code instructions further include program code instructions configured to sort the plurality of products based upon the likelihoods that respective products were manually selected. The program code instructions of this example embodiment that are configured to cause presentation of information regarding the one or more of the products also include program code instructions configured to cause presentation of information regarded two or more of the plurality of products with the information ordered pursuant to the sorting.

The shopper may be associated with one or more additional shoppers. In this example embodiment, the program code instructions configured to perform the comparison include program code instructions configured to perform, for each of the plurality of products and for each of the shoppers, the comparison of one or more locations of a respective shopper relative to the location of the respective product. The program code instructions of this example embodiment that are configured to determine the likelihood include program code instructions configured to determine, for each of the plurality of products, the likelihood that the respective product was selected by any one of the shoppers based upon the comparison of the one or more locations of the respective shoppers relative to the location of the respective product.

In yet another example embodiment, an apparatus is provided that is configured to identify a selected product based on location. For each of a plurality of products, the apparatus includes means for performing a comparison of one or more locations of a shopper relative to a location of a respective product. For each of the plurality of products, the apparatus also includes means for determining, based upon the comparison of the one or more locations of the shopper relative to the location of the respective product, a likelihood that the respective product was manually selected. Based on the likelihoods that respective products were manually selected, the apparatus further includes means for identifying one or more of the plurality of products.

The means for determining the likelihood in accordance with an example embodiment include means for determining the likelihood that the respective product was manually selected based also upon a time at which the location of the shopper was proximate the respective product. In this example embodiment, the means for determining the likelihood include means for determining the likelihood that the respective product was manually selected based upon a difference between the time at which the location of the shopper was proximate the respective product and a time at which the shopper is proximate a terminal at which the respective product is to be identified. The terminal may comprise or be associated with scales configured to weigh the respective product. In this example embodiment, the means for determining the likelihood may also include means for evaluating a probability function having an inverse relationship to the difference between the time at which the location of the shopper was proximate the respective product and the time at which the shopper is proximate the terminal at which the respective product is to be identified.

The means for performing the comparison in accordance with an example embodiment includes means for determining, for each of the plurality of products, a minimum distance between the one or more locations of the shopper and the location of the respective product. In this example embodiment, the apparatus also includes means for determining, for each of the plurality of products, a time at which the shopper was located at the minimum distance from the location of the respective product. Also in accordance with this example embodiment, the means for determining the likelihood may include means for determining the likelihood that the respective product was manually selected based upon the difference between the time at which the location of the shopper was located at the minimum distance from the location of the respective product and the time at which the shopper is proximate the terminal at which the respective product is to be identified.

The means for determining the likelihood in accordance with an example embodiment include means for modifying the likelihood in a manner that is dependent upon a speed at which the shopper is walking proximate the location of the respective product. In an example embodiment, the means for determining the likelihood includes means for modifying the likelihood in a manner that is dependent upon an amount of time expended by the shopper proximate the location of the respective product. The apparatus of an example embodiment also includes means for determining the one or more locations of the shopper utilizing an indoor positioning technique. The apparatus of an example embodiment also includes means for causing presentation of information regarding the one or more of the products that were identified to facilitate selection by the shopper. For example, the apparatus may include means for causing information regarding the one or more of the products that were identified to be displayed upon a terminal that comprises or is associated with scales configured to weigh the respective product. In this example embodiment, the apparatus further includes means for sorting the plurality of products based upon the likelihoods that respective products were manually selected. The means for causing presentation of information regarding the one or more of the products in accordance with this example embodiment also includes means for causing presentation of information regarded two or more of the plurality of products with the information ordered pursuant to the sorting.

The shopper may be associated with one or more additional shoppers. In this example embodiment, the means for performing the comparison includes means for performing, for each of the plurality of products and for each of the shoppers, the comparison of one or more locations of a respective shopper relative to the location of the respective product. The means for determining the likelihood in accordance with this example embodiment also includes means for determining, for each of the plurality of products, the likelihood that the respective product was selected by any one of the shoppers based upon the comparison of the one or more locations of the respective shoppers relative to the location of the respective product.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 depicts a portion of a store in which a plurality of different products are available for selection by a shopper from different containers in which the products are displayed along with an indication of a route of a shopper through the illustrated portion of the store;

FIG. 2 is a block diagram illustrating a system including an apparatus configured to identify a selected product based on location in accordance with an example embodiment of the present disclosure;

FIG. 3 is a block diagram of an apparatus configured in accordance with an example embodiment in order to identify a selected product based on location;

FIG. 4 is a flow chart illustrating operations performed, such as by the apparatus of FIG. 3, in accordance with an example embodiment; and

FIG. 5 illustrates a user interface including information regarding plurality of products that were identified as being likely to have been selected in accordance with an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in accordance with an example embodiment in order to identify a selected product based on location. As described below, the identification of a selected product based on location is based on a comparison of one or more locations of the shopper relative to the location of a respective product. A variety of different types of products may be identified based on location. In at least some embodiments, the products are not individually packaged and are also not packaged as a part of a larger set. Instead, the products may be presented to the shopper in the form of loose items or in bulk with the shopper permitted to select a desired quantity of a product. The price to be paid for the selected product is then generally based upon an identification of the product itself and the quantity or weight of the product that has been selected by the shopper. As will be used hereinafter by way of example, but not of limitation, produce, that is, fruits and vegetables, are frequently presented to shoppers in containers or bins within which a plurality of a respective product are loosely presented. For example, one container may include a plurality of a first type of tomato, a second container may include a plurality of a second type of tomato, a third container may include a plurality of a first type of apple, a fourth container may include a plurality of a second type of apple and so forth. The shopper may therefore select any number of the different types of tomatoes, apples, or other types of fruits or vegetable with the price to paid by the shopper based upon the weight of each different type of fruit or vegetable that has been selected.

Other examples of products that may be loosely presented in bulk include coffee, nuts, legumes and candy with the shopper allowed to select a desired quantity of the coffee, nuts, legumes or candy with the price to be paid by the shopper based upon the selected quantity. Additionally, the products may be in other forms such as liquid products that are presented in bulk with a shopper then dispensing a desired quantity of the liquid into a bottle or the like for purchase. For example, liquid products that may be presented in bulk and dispensed in this manner may include drinkable liquids, cleaning liquids, washing liquids, laundry liquids and dish washing liquids.

Although the forgoing examples of products that may selected by a shopper are products that are provided by grocery store, the products that may selected and identified in accordance with an example embodiment of the present disclosure are not limited to products provided for sale by a grocery store and, instead, may include a wide variety of other products sold by other types of retailers. For example, hardware items, such as screws, bolts, nuts, washers, nails, etc. may be presented to a shopper in bulk with a shopper allowed to select a desired quantity of the respective product with the price paid by the shopper for the selected product being based upon the selected quantity of the product.

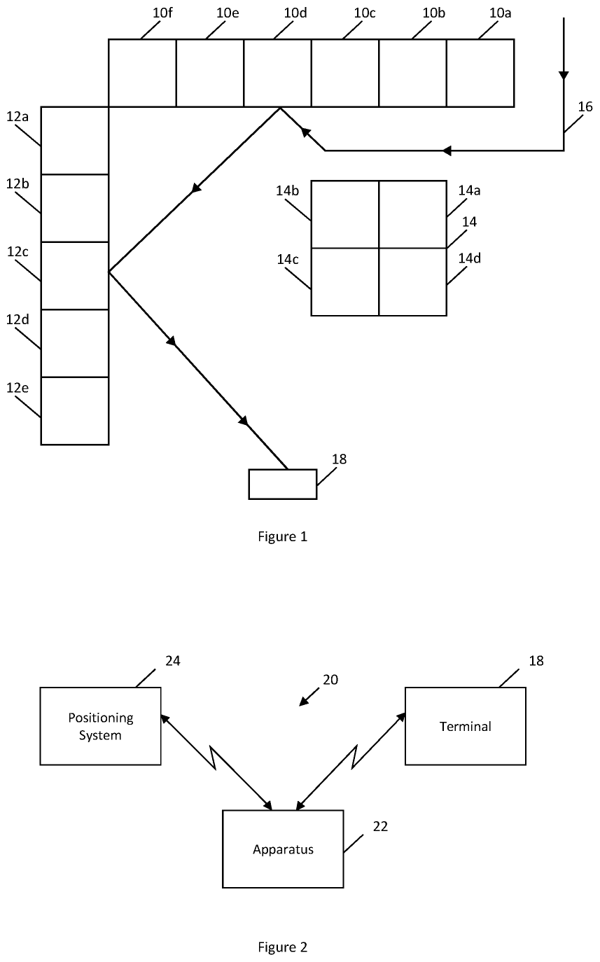

As noted above, the product that is selected may be identified based on location and, more particularly, based on a comparison of locations of the shopper relative to a location of a respective product. As shown in FIG. 1, the location of a shopper generally varies over the course of time as the shopper walks through the store and selects various products for purchase. Not all shoppers follow the same route through a store with the route followed by a shopper depending on a variety of factors including the products sought by the shopper, the shopper's personal preferences relative to the manner in which the store is traversed, the floor plan of the store and the layout of the products therein, etc. As such, the location of a shopper within a store relative to the various products sold by the store will vary as the shopper traverses throughout the store.

By way of example, FIG. 1 depicts a portion of a store and, more particularly, a portion of a produce section of a store. As shown, this portion of the produce section includes a plurality of containers with each container including a respective type of fruit or vegetable. The containers may each include a different type of fruit or vegetable from the types of fruits and vegetables in the other containers, or two or more the containers may include the same type of fruit or vegetable. In this regard, reference to a type of product relates to a product identified by a respective product identifier, such as a respective stock keeping unit (SKU). By way of example, a first set 10 of containers, such as containers 10a, 10b, 10c, 10d, 10e and 10f, may respectively include different types of apples with container 10a including a plurality of a first type of apples, container 10b including a plurality of a second type of apples, container 10c including a plurality of a third type of apples, container 10d including a plurality of a fourth type of apples, container 10e including a plurality of a fifth type of apples and container 10f including a plurality of a sixth type of apples. In the example of FIG. 1, a second set 12 of containers, such as containers 12a, 12b, 12c, 12d and 12e, may respectively include different types of tomatoes with container 12a including a plurality of a first type of tomato, container 12b including a plurality of a second type of tomato, container 12c including a plurality of a third type of tomato, container 12d including a plurality of a fourth type of tomato and container 12e including a plurality of a fifth type of tomato. Further, the produce section of this example also includes a third set 14 of containers, such as containers 14a, 14b, 14c and 14d. These containers may respectively include different types of potatoes with container 14a including a plurality of a first type of potatoes, container 14b including a plurality of a second type of potatoes, container 14c including a plurality of a third type of potatoes and container 14d including a plurality of a fourth type of potatoes.

As shown FIG. 1, the route 16 taken by shopper through this portion of the produce section is also depicted. As the route indicates, the shopper most closely approaches containers 10d containing a fourth type of apples and container 12c containing a third type of tomato during the shopper's movement through the illustrated portion of the produce section. In some example embodiments, a terminal 18 that includes or is associated with scales for weighing a selected product may also be available to permit a shopper to weigh the selected product and to determine the price associated therewith. In the embodiment of FIG. 1, for example, the route of the shopper approaches the terminal after having walked through this portion of the produce section.

In order to base the determination of a selected product upon location, the location of the shopper is determined. The location of the shopper may be determined in various manners. For example, in some instances the products selected by a shopper may be outdoors, such as on a sidewalk in front of store, in an outdoor market, e.g., a farmers market, or the like. In these instances, the location of the shopper may be determined utilizing any of a variety of outdoor positioning techniques, such as satellite or cellular positioning techniques. In this regard a satellite positioning technique that utilizes a global positioning system (GPS) may determine the location of a shopper by tracking the GPS sensor of a mobile terminal, such as a mobile telephone, carried by the shopper. However, the products selected by a shopper that are to be identified in accordance with an example embodiment are frequently located indoors. As such, satellite and cellular positioning techniques cannot generally locate a shopper indoors with the desired accuracy, such to within 2 to 3 meters, and coverage, such as approaching 100% coverage, and with the provision of floor detection, such as by determining the floor of a multi-story building on which a shopper is located. In this regard, satellite-based radio navigation signals generally fail to penetrate sufficiently through a structure, such as the walls and the roof, to allow for adequate signal reception for sufficient positioning accuracy, coverage and floor detection in an indoors environment. Additionally, cellular signals may have a bandwidth that is too narrow to provide accurate ranging.

As such, the location of a shopper who is indoors in accordance with an example embodiment may be determined by an indoor positioning technique. Any of a wide variety of indoor positioning techniques may be utilized including techniques that utilize short-range beacons termed pseudolites, ultra-sound positioning techniques, techniques utilizing Bluetooth Low Energy (BTLE) signals, Wi-Fi fingerprint techniques, techniques that utilize the ultra-wide band radio, camera and/or audio interface of a mobile terminal of the shopper, imaging techniques utilizing a camera system of the store or techniques that rely on sensor fusion. In an example embodiment, however, the location of a shopper may be determined by a radio-based indoor positioning technique that models the radio environment, such as the Wi-Fi radio environment, the Bluetooth radio environment or the like, from observed Received Signal Strength (RSS) measurements as two-dimensional radio maps, thereby capturing the indoor radio propagation environment in a compressible and accurate manner. Separate radio maps may be created for different floors of a building in order to also provide for reliable floor detection.

The positioning system 24 may be part of a system 20 as shown in FIG. 2 that also includes an apparatus 22 configured to identify a selected product based on location. The apparatus may be embodied by a variety of different computing devices. For example, the apparatus may be embodied by a mobile terminal carried by a shopper while selecting products within a store. In this example embodiment, the apparatus may be embodied by a mobile terminal, e.g., a personal digital assistant (PDA), mobile telephone, smart phone, personal navigation device, smart watch, tablet computer, or any combination of the aforementioned and other types of portable computer devices. Alternatively, the apparatus may be embodied by a computing device that is separate from the shopper, but, in some embodiments, may still be in communication with a mobile terminal carried by the shopper. In an embodiment in which the apparatus is separate from the shopper, the apparatus of one embodiment may be associated with the store in which the shopper is shopping and/or with the positioning system. In these example embodiments, the apparatus may be embodied by a server, a computer workstation, a distributed network of computing devices, a personal computer or any other type of computing device.

As shown in FIG. 2, the apparatus 22 is in communication with a positioning system 24 and a terminal 18 positioned within or otherwise associated with respect to the store within which the shopper is shopping. The positioning system is configured to determine the location of the shopper at each of a plurality of points in time as a shopper proceeds throughout the store and selects one or more products. As described above, the positioning system may be any of a wide variety of different types of positioning systems including outdoor positioning systems, such as satellite and cellular radio positioning systems, and/or an indoor positioning system including, for example, any of the indoor positioning systems described above. In one embodiment, the positioning system is a radio-based indoor positioning system that models the radio environment from observed RSS measurements as two-dimensional radio maps. Still further, the indoor positioning system may be an image-based positioning system that receives images captured by one or more cameras positioned throughout the store and performs image analysis upon the captured images to identify the shopper and the location of the shopper within the store at different points in time.

As shown in FIG. 2, the positioning system 24 may be separate from the apparatus 22 that is configured to identify the selected products based on location. In this embodiment and in an instance in which the positioning system is a radio-based indoor positioning system that relies upon observed RSS measurements to determine the location with respect to a two-dimensional radio map, the positioning system will be in communication with the mobile terminal carried by the shopper to obtain the RSS measurements as the shopper moves throughout the store, such as indicated by the communication link between the positioning system and the apparatus in FIG. 2. In another embodiment, the apparatus that is configured to identify the selected products may include the positioning system.

As to the terminal 18, the terminal may include a user interface with which the shopper interacts as described below. The terminal may also include or otherwise be associated with scales for weighing the selected products. As also shown in FIG. 2, the terminal may be in communication with the apparatus 22 that is configured to identify the selected product in order to configure the user interface to facilitate subsequent identification of the selected products by the shopper, such as in conjunction with weighing of the selected products. Although the apparatus is depicted to be separate from, but in the communication with the terminal, the apparatus of some example embodiments may, instead, be embodied by the terminal or by another computing system of the store.

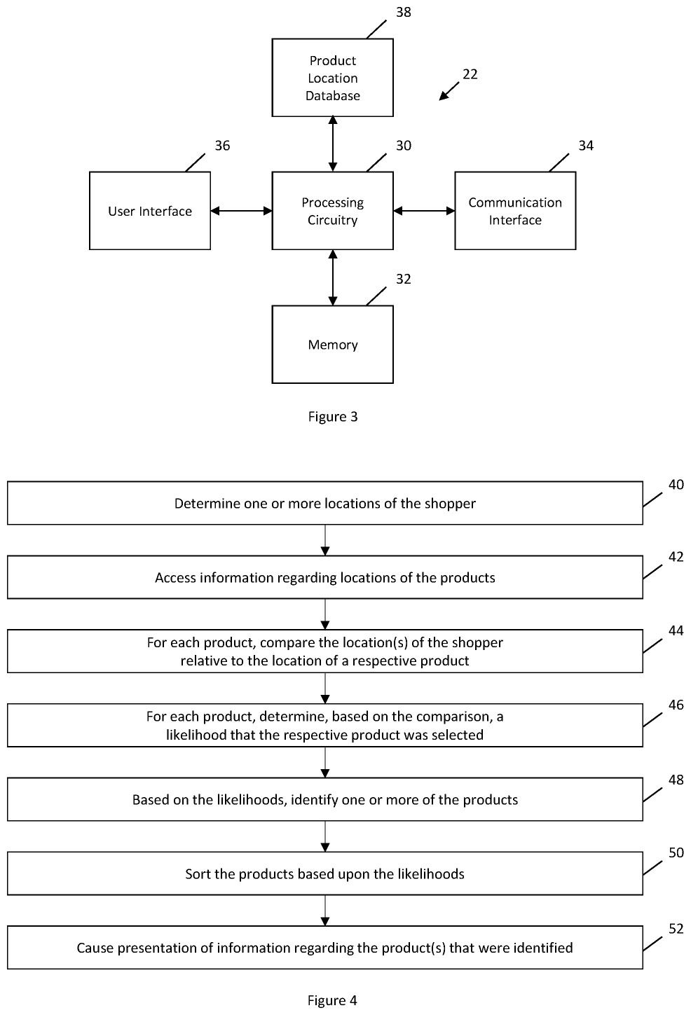

Referring now to FIG. 3, an apparatus 22 configured to identify the selected products based on location is depicted in accordance with an example embodiment. As noted above, the apparatus may be embodied by any of variety of computing devices including a mobile terminal carried by the shopper, the positioning system 24, the terminal 18 or other computing system associated with the store or the like. Regardless of the manner in which the apparatus is embodied, the apparatus of an example embodiment includes, is associated with or is otherwise in communication with processing circuitry 30 and a memory 32 and optionally with a communication interface 34 and/or a user interface 36. As shown in FIG. 3 and as described below, the apparatus may also be in communication with database 38, such as a database that includes information defining the location of a plurality of different products throughout a store. Although the apparatus may include the database, the apparatus of some example embodiments is configured to communicate with an external database, such as a database maintained by the store, in order to obtain the information regarding the locations of the different products.

In some embodiments, the processing circuitry 30 (and/or co-processors or any other processors assisting or otherwise associated with the processing circuitry) can be in communication with the memory 32 via a bus for passing information among components of the apparatus 22. The memory can be non-transitory and can include, for example, one or more volatile and/or non-volatile memories. In other words, for example, the memory may be an electronic storage device (for example, a computer readable storage medium) comprising gates configured to store data (for example, bits) that can be retrievable by a machine (for example, a computing device like the processing circuitry). The memory can be configured to store information, data, content, applications, instructions, or the like for enabling the apparatus to carry out various functions in accordance with an example embodiment of the present disclosure. For example, the memory can be configured to buffer input data for processing by the processing circuitry. Additionally or alternatively, the memory can be configured to store instructions for execution by the processing circuitry.

The processing circuitry 30 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally or alternatively, the processing circuitry can include one or more processors configured in tandem via the bus to enable independent execution of instructions, pipelining and/or multithreading.

In an example embodiment, the processing circuitry 30 can be configured to execute instructions stored in the memory 32 or otherwise accessible to the processing circuitry. Alternatively or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 22 of an example embodiment can also optionally include the communication interface 34, such as in instances in which the apparatus is separate from, but in communication with the positioning system 24 and/or the terminal 18. The communication interface can be any means such as a device or circuitry embodied in either hardware or a combination of hardware and software that is configured to receive and/or transmit data from/to other electronic devices in communication with the apparatus, such as the positioning system and/or the terminal and/or the database 38 in embodiments in which the product location database is remote from, but in communication with the apparatus. Additionally or alternatively, the communication interface can be configured to communicate in accordance with various wireless protocols including Global System for Mobile Communications (GSM), such as but not limited to Long Term Evolution (LTE). In this regard, the communication interface can include, for example, an antenna (or multiple antennas) and supporting hardware and/or software for enabling communications with a wireless communication network. In this regard, the communication interface can include, for example, an antenna (or multiple antennas) and supporting hardware and/or software for enabling communications with a wireless communication network. Additionally or alternatively, the communication interface can include the circuitry for interacting with the antenna(s) to cause transmission of signals via the antenna(s) or to handle receipt of signals received via the antenna(s). In some environments, the communication interface can alternatively or also support wired communication.

The apparatus 22 may also optionally include a user interface 36 that may, in turn, be in communication with the processing circuitry 30 to provide output to the user and, in some embodiments, to receive an indication of a user input. For example, the apparatus may include a user interface in those example embodiments in which the apparatus is embodied by the terminal 18. The user interface may include a display and, in some embodiments, may also include a keyboard, a mouse, a joystick, a touch screen, touch areas, soft keys, one or more microphones, a plurality of speakers, or other input/output mechanisms. In one embodiment, the processing circuitry may comprise user interface circuitry configured to control at least some functions of one or more user interface elements such as a display and, in some embodiments, a plurality of speakers, a ringer, one or more microphones and/or the like. The processing circuitry and/or user interface circuitry embodied by the processing circuitry may be configured to control one or more functions of one or more user interface elements through computer program instructions (for example, software and/or firmware) stored on a memory accessible to the processing circuitry (for example, memory 32, and/or the like).

Referring now to FIG. 4, the operations performed, such as by the apparatus 22 of FIG. 3, in accordance with an example embodiment are depicted. The process of FIG. 4 may be initiated in any of various manners. For example, the mobile terminal carried by a shopper may have been previously registered with the store and, more particularly, with the apparatus, such as in conjunction with registration for a frequent shopper program, registration for a program to automatically identify products selected by the shopper or otherwise. As such, the apparatus, such as the processing circuitry 30, communication interface 34 or the like, of an example embodiment may be configured to automatically identify the mobile terminal carried by the shopper as the shopper enters the store and to initiate the process described below in conjunction with FIG. 4 in response to identification of the mobile terminal. Alternatively, the positioning system 24 of another example embodiment may be tracking the location of the of shopper even before the shopper arrives at the store. Upon detecting that the location of the shopper coincides with the location of the store, however, the positioning system may communicate with the apparatus, such as the processing circuitry, communication interface or the like, in order to initiate the process described below in conjunction with FIG. 4. Still further, the shopper may manually initiate the process described below in conjunction with FIG. 4, such as prior to or upon entering the store. In this example embodiment, the shopper may initiate the process depicted in FIG. 4 in various manners including, for example, by launching an application (“app”) provided by the mobile terminal carried by the shopper.

As shown in block 40, the apparatus 22 of an example embodiment includes means, such as the processing circuitry 30, the communication interface 34 or the like, for determining one or more locations of the shopper throughout the store, such as at different times along the route 16 of the shopper as depicted by way of example in FIG. 1. The locations of the shopper may be determined utilizing any one or more of the positioning techniques described above as well as any other positioning techniques. In an example embodiment, however, the locations of the shopper throughout the store are determined by an indoor positioning technique, such as a radio-based indoor positioning system that utilizes RSS measurements captured by the mobile terminal carried by the shopper to determine the location of the shopper with respect to a two-dimensional radio map. In an embodiment in which the apparatus includes the positioning system 24, the apparatus, such as the processing circuitry, the communication interface or like, may be configured to determine the location of the shopper within the in store. Alternatively, the apparatus may be in communication with an external positioning system, such as shown in FIG. 2. In this example embodiment, the apparatus, such as the processing circuitry the communication interface or like, is configured to determine the location of the shopper by receiving information from the positioning system that defines the location of the shopper within the store at different points in time.

As shown in block 42 of FIG. 4, the apparatus 22 of an example embodiment also includes means, such as the processing circuitry 30, the communication interface 34 or the like, for obtaining information defining the locations of a plurality of different products in the store. The information regarding the locations of the products within the store may be provided in various manners. In an example embodiment, however, the apparatus, such as the processing circuitry the communication interface or the like, is in communication with the database 38 associated with the store that maintains information regarding the locations of a plurality of products within the store. The products for which information regarding the respective locations are maintained by the database include those products that are loosely displayed to a shopper without packaging or otherwise presented in bulk for a shopper to select the amount or quantity of the product that is desired. Thus, the database of one example embodiment that is associated with a grocery store includes the locations of a plurality of different types of fruits and vegetables, nuts, legumes, coffee, candy, etc., while the database associated with a hardware would provide information regarding the locations of plurality of different types of hardware items, such as screws, bolts, nuts, washers, nails, etc.

As shown in block 44 of FIG. 4, the apparatus 22 of an example embodiment includes means, such as the processing circuitry 30 or the like, for performing a comparison, separately for each of a plurality of products, of one or more locations of the shopper relative to the location of the respective product. By way of example, the processing circuitry may be configured to compare the location(s) of the shopper to the location of a first product, to compare the location(s) of the shopper to the location of a second product, and so on for each of the plurality of products for which locations are provided, such as by the database 38.

In an example embodiment, the apparatus 22, such as the processing circuitry 30, is configured to perform the comparison by determining, for each of the plurality of products, a minimum distance between the location of the shopper as the shopper moves throughout the store, and the location of the respective product. Thus, for a first product, the apparatus, such as the processing circuitry, is configured to compare the location of the first product to the plurality of locations of the shopper as the shopper moves throughout the store and to identify the particular location at which the shopper was located a minimum distance from the first product. The apparatus, such as the processing circuitry, then repeats the process for a second product, a third product, and so on for each of the plurality of products for which location information was obtained, such as from the database 38.

In this example embodiment, the apparatus 22, such as the processing circuitry 30, is configured to the perform the comparison by also determining, for each of the plurality of products, a time at which the shopper is located at the minimum distance from the location of the respective product. In this regard, the positioning system 24 not only determines the locations of the shopper at a plurality of points in times as the shopper moves throughout a store, but also associates each of the locations of the shopper with a respective time, e.g., a timestamp, at which the shopper was at the particular location.

Referring now to the block 46 of FIG. 4, the apparatus 22 also includes means, such as the processing circuitry 30 or the like, for determining, for each of the plurality of products and based upon the comparison of the one or more locations of the shopper relative to the location of the respective product, a likelihood that a respective product was manually selected, such as by being selected by the shopper from the container within which the product is displayed. In this regard, the apparatus, such as the processing circuitry, of an example embodiment is configured to determine the likelihood of selection of a respective product in accordance with an inverse relationship with respect to the minimum distance between the shopper and the respective product. Thus, the likelihood that a respective product was selected is greater in an instance in which the minimum distance between the shopper and the respect product is smaller, while the likelihood that a respective product was selected is less in an instance in which the minimum distance between the shopper and a respective product is larger.

In an example embodiment, the apparatus 22, such as the processing circuitry 30, is configured to not only determine the likelihood that a respective product was manually selected based upon the location of the shopper relative to the respective product, such as based upon the minimum distance between the shopper and the respective product, but also based upon the time at which the shopper was proximate the respective product. In this example, embodiment, the apparatus, such as the processing circuitry, is also configured to determine the likelihood that the respective product was manually selected based upon the time at which the location of the shopper was proximate the respective product and, in one embodiment, based upon a difference between the time at which the location of the shopper was proximate the respective product and the time at which the shopper is proximate a terminal 18, such as a terminal of the store, that includes or is associated with scales configured to weigh the respective product, at which the respective product is to be identified. In this regard, the terminal may be a point of sale terminal, or a terminal including a user interface that is associated with scales to weigh the respective product, such as may be located throughout the store in proximity to the respective products prior transitioning to the point of sale.

In this example embodiment, the apparatus 22, such as the processing circuitry 30, is configured to determine the likelihood that a respective product was selected by evaluating a probability function having an inverse relationship to the difference between the time at which the location of the shopper was proximate the respective product and the time at which the shopper is proximate the terminal 18 at which the respective product is to be identified, such as the time at which the shopper interacts with the terminal. In an embodiment in which the apparatus, such as the processing circuitry, determines the minimum distance between each respective product and the location of the shopper, the apparatus, such as the processing circuitry is configured to determine the likelihood that a respective product was manually selected not only based upon the minimum distance, but also based upon the difference between the time at which the location the shopper was located at the minimum distance from the respective product and time at which the shopper is proximate the terminal at which the respective product is to be identified.

The apparatus 22, such as the processing circuitry 30, may be configured to determine the likelihood that a respective product was selected for all of the products, such as all of the products for which information was provided by the database 38. Alternatively, the apparatus, such as the processing circuitry, may be configured to determine the likelihood for only a subset of the products, such as the products for which the minimum distance satisfies a threshold, such as by being less than a threshold, and/or the products for which the elapsed time between the time at which the location of the shopper was proximate the respective product and the time at which the shopper is proximate the terminal 18 satisfies a threshold, such as by being less than a threshold.

By way of example, the apparatus 22, such as the processing circuitry 30, may be configured to determine the likelihoods that products {P₁, P₂, . . . , Pₙ_{_{P}}} were manually selected based on the location history ( [symbol] ₁, [symbol] ₂, . . . , [symbol] ) of the shopper corresponding to different respective time instants (t₁, t₂, . . . , [symbol] ). In this regard, for each product Pᵢ having a location designated as pᵢ, the apparatus, such as the processing circuitry, of this example embodiment is configured to determine the customer location index jₘᵢₙ that minimizes the distance to the product location, jₘᵢₙ=argminⱼ∥ [symbol] ⱼ−pᵢ∥. Thus, the apparatus, such as the processing circuitry, is configured to determine the minimum distance dᵢ of the product from the customer location history dᵢ=∥ [symbol] ⱼ_{ₘᵢₙ}−pᵢ∥. For each product Pᵢ for which the minimum distance dᵢ satisfies a threshold, such as by being less than a threshold, and for which the elapsed time t between the time tⱼ_{ₘᵢₙ} at which the shopper was located the minimum distance dᵢ from the product Pᵢ and the time from the product to the time t_{scales} at which the shopper is proximate the scales, e.g., t=t_{scales}−tⱼ_{ₘᵢₙ} is less than a threshold, the apparatus, such as the processing circuitry, of this example embodiment is configured to evaluate a probability function

$${π}_{i} = \frac{f ( t )}{{d}_{i}}$$

to determine the likelihood that a respective product Pᵢ was manually selected. In this example, ƒ is a decreasing function that more greatly weights products that the customer approached more recently prior to going to the scales.

The apparatus 22, such as the processing circuitry 30, of an example embodiment may also be configured to determine the likelihood that a respective product was manually selected based upon one or more additional factors in combination with the comparison of the locations of the shopper to then location of the respective product and, in some embodiments, the time at which the location of the shopper was proximate the respective product. For example, the apparatus, such as the processing circuitry, of one embodiment may also be configured to determine the likelihood that a respective product was manually selected by modifying the likelihood in a manner that is dependent upon the speed at which the shopper is walking proximate the location of the respective product. In this regard, the apparatus, such as the processing circuitry, is configured to modify the likelihood in a manner that has an inverse relationship to the speed with which the shopper is walking proximate the location of the respective product. Thus, in an instance in which a shopper is walking faster proximate the location of the respective product, the apparatus, such as the processing circuitry, of this example embodiment is configured to the reduce the likelihood that the respective productive was manually selected. Alternatively, in an instance in which a shopper is walking slower proximate the location of the respective product, the apparatus, such as the processing circuitry, of this example embodiment is configured to the increase the likelihood that the respective productive was manually selected.

The speed with which a shopper is walking may be determined in various manners including by any of variety of sensors including motion sensors, speed sensors, etc., of the mobile terminal carried by the shopper. Alternatively, the speed of the shopper may be determined by the positioning system 24 based upon the relationship in the change in location to the change in time between locations on either side of the respective product, such as between locations separated by at least a predefined distance on either side of the respective product.

In another example embodiment, the apparatus 22, such as the processing circuitry 30, is configured to determine the likelihood that a respective product was manually selected by modifying the likelihood in a manner that is dependent upon the amount of time expended by the shopper proximate the location of the respective product. In this regard, the apparatus, such as the processing circuitry, is configured to determine the likelihood that a respective product was manually selected by modifying the likelihood so as to have a direct relationship to the amount of time expended by the shopper proximate the location of the respective product. Thus, in an instance in which the shopper expends a longer time proximate the location of the respective product, the likelihood that the shopper selected the respective product is increased, while the likelihood is corresponding decreased in an instance in which the shopper expends a shorter time proximate the location of the respective product.

The amount of time expended by a shopper proximate the location of a respective product may be determined various manners including, for example, by the positioning system 24. In this example embodiment, the positioning system is configured to determine the length of time that a shopper is within a predefined distance of the product based upon the plurality of locations of the shopper and the times at which the shopper was within a predefined distance of the location of the respective product. In another example embodiment, the positioning system is configured to determine the length of time that the shopper was at the minimum distance from the respective product or within a distance based upon the minimum distance, such as 150% of minimum distance, from the respective product.

While a likelihood may be defined for each of the plurality of products, the apparatus 22, such as the processing circuitry 30, of an example embodiment is configured to determine the likelihood for each of the plurality of products for which a location is provided by the database 38 or only for those products identified by the database with which the shopper comes within a predefined distance. In this example embodiment, the apparatus, such as the processing circuitry, may be configured to only identify the likelihood that a respective product is manually selected in an instance in which the minimum distance between the location of the shopper and the location of a respective product is less than a predefined threshold, thereby conserving processing resources.

Referring now to block 48 of FIG. 4, the apparatus 22 of an example embodiment also includes means, such as the processing circuitry 30, the user interface 36 or the like, for identifying one or more of the plurality of products based on the likelihood that the respective products were manually selected. While the apparatus, such as the processing circuitry, may be configured to identify each of the products for which a likelihood has been determined, the apparatus, such as the processing circuitry, of an example embodiment is configured to identify no more than a predefined number of products, such as 5 products, 10 products or the like. In this embodiment in which less than all of products for which a likelihood has been determined are identified, the apparatus, such as the processing circuitry, is configured to identify the predefined number of products that have the greatest likelihood associated therewith.

As shown in block 50 of FIG. 4, the apparatus 22 of an example embodiment may also include means, such as the processing circuitry 30 or like, for sorting the plurality of the products based upon the likelihood that respective products were manually selected. In this regard, the apparatus, such as the processing circuitry, is configured to sort the products to be in an order dependent upon the respective likelihoods that the respective products were manually selected. For example, the products may be sorted so as to be in a descending order from the product that is most likely to have been manually selected to the product that is least likely to have been manually selected. Based upon the sorting of the products, the apparatus, such as the processing circuitry, of this example embodiment is configured to identify a plurality of products, such as a predefined number of products, having the greatest likelihoods of having been manually selected by the shopper.

As shown in block 52, the apparatus 22 of an example embodiment also includes means, such as the processing circuitry 30, the communication interface 34, the user interface 36 or like, for causing presentation of information regarding the one or more products that were identified to facilitate selection by a shopper. In an example embodiment, the apparatus, such as the processing circuitry, may be configured to cause presentation of information regarding the one or more products that were identified by causing the information regarding the one or more products that were identified to be displayed upon the terminal 18, such as a user interface of the terminal, that includes or is associated with scales configured to weigh the respective product. The information that is presented may be varied, but generally identifies a respective product, such as information providing the name of the product, pictorial or other imagery illustrating the product, numerical information providing a numerical identifier associated with the product, etc.

In one embodiment, the apparatus 22 or a portion thereof (such as the processing circuitry 30) is configured to cause the presentation of information regarding the identified product(s) to be presented once the shopper has begun to interact with the terminal 18, such as by providing an input requesting the presentation of the information regarding the identified product(s). In another example embodiment, the apparatus, such as the processing circuitry, is configured to cause the presentation of information regarding the identified product(s) automatically once the shopper is proximate the terminal. In this example embodiment, the apparatus, such as the processing circuitry, may be configured to detect the proximity of the shopper to the terminal, such as based upon communication therebetween (or to receive an indication that the shopper is proximate the terminal) and may then automatically cause the information regarding the identified product(s) to be presented.

In an embodiment in which the products have been sorted based upon the likelihood that the products were manually selected, the information that is presented to the shopper may be displayed in a manner that is based upon the sorting of the products and, as a result, based upon the relative likelihood that the respective products were manually selected. For example, the information regarding the one or more products that were identified based upon the likelihoods that the respective products were manually selected may be sorted and then displayed in a descending order from the product that has the greatest likelihood of having been selected to the product that has the least likelihood of having been selected, from among the plurality of products that were identified as candidates to be the selected product.

For example, after having selected a product and, in some instances, placed the product in a bag or other container, the shopper may proceed to the terminal 18 in order to determine the price of the product that has been selected. In order to determine the price, the shopper of this example embodiment may place the product on the scales and the apparatus 22, such as the processing circuitry 30, may be configured to cause information to be presented, such as upon a user interface of the terminal that includes or is associated with the scales, that identifies the one or more products that have been identified, such as the one or more products having the greatest likelihood of having been selected by the shopper. The shopper may then view the information and select the product, from among the products for which information is displayed by the terminal, that was actually selected by the shopper and is now being weighed such that price that the shopper will pay for the product can be determined. In an instance in which the product that has been selected is not included in the information that is displayed by the terminal, the terminal, such as the user interface of the terminal, may include an option, such as a key, a soft key or the like, that may be selected by the shopper that then allows the shopper to identify the product that has been selected, such as by reference to a product identifier or via use of a hierarchical menu as described above.

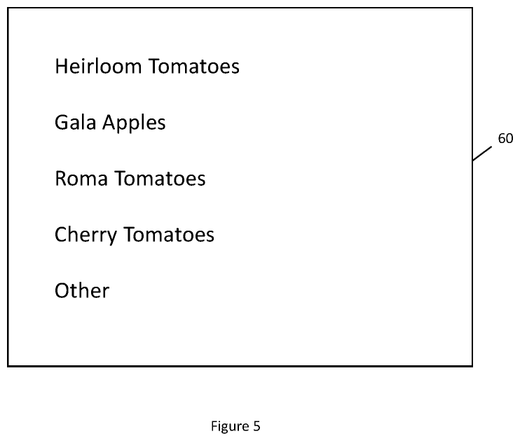

By way of example, FIG. 5 depicts information 60 displayed by the terminal 18 of FIG. 1. The information displayed identifies four products by name that have the greatest likelihood of having been selected. The likelihood is determined in this example based on the minimum distance of the shopper from the location of a product and also based on the elapsed time between the time at which the shopper was located the minimum distance from the location of the product and the time that the shopper is proximate the terminal. Of these factors, minimum distance is weighted more greatly than the elapsed time. The products of FIG. 5 are identified in descending order of the likelihood of having been selected such that Heirloom tomatoes are identified to be the most likely to have been selected and Cherry tomatoes are identified the least likely of the four products to have been selected.

As the likelihood is determined in this example to be based primarily on the minimum distance and secondarily on the elapsed time, Heirloom tomatoes that are located in container 12c are identified to be the most likely since of the containers that the shopper approached most closely, the shopper approached the Heirloom tomatoes in container 12c most recently. Similarly, Gala apples that are located in container 10d are identified to be the second most likely since the shopper also closely approached the Gala apples in container 10d, but more time has elapsed between the time at which the shopper approached the Gala apples and the time at which the shopper interacts with the terminal. As shown in FIG. 5, Roma tomatoes in container 12d and Cherry tomatoes in container 12b are identified as the third and fourth most likely products to have been manually selected since the shopper recently approached both containers 12b and 12d, but maintained some distance from each container. Thus, the shopper can select one of the products that are identified by the terminal 18 as the product that is being weighted. Or, if none of the products that are identified by the terminal were selected by the shopper, the shopper can select “Other” in order to identify the product that was selected and is being weighed in a conventional manner, e.g., by reference to a product identifier or via use of a hierarchical menu as described above.

As will be noted, this process is efficient for the shopper who generally needs not input any specific information, such as a product identifier, other than providing a selection of a previously identified product. Moreover, this process increases the accuracy with which products are identified by reducing the number of options at least initially available to a shopper to include only those options that are most likely. Further, this process is efficient from the standpoint of the stores in that the process operates in an automated fashion without dependency upon an employee of the store to identify the product and to input the related information. Further, the process may be performed in a timely manner in order to potentially reduce the hardware requirements for a store since the same number of terminals 18 may be utilized by a larger number of shoppers or the same number of shoppers may be serviced by a smaller number of terminals due to the speed and efficiency with which the selected products are identified, first by the apparatus 22, such as the processing circuitry 30, and then by the shopper from among the more limited list of most likely products.

In an embodiment in which the terminal 18 upon which the information regarding the products that were identified to be candidates to have been manually selected is presented is proximate the location of the products and in advance of the point of sale, such as shown in FIG. 1, the apparatus 22, such as the processing circuitry 30, of an example embodiment may be configured to determine the likelihood that a respective product was manually selected based not only upon the comparison of the locations of the shopper and the respective product, but also based upon the time at which the shopper was located proximate the respective product, such as the difference in time between the time at which the shopper was located proximate the respective product and the time a which the shopper is located proximate the terminal, such as the time at which the shopper initially interacts with the terminal. In this regard, a shopper may manually select a product and then proceed directly to the terminal in order to weigh the selected product. As such, the elapsed between the time at which the shopper selected a respective product and the time at which the shopper is present at the terminal and is, for example, weighing the selected product is instructive as to the product that has most likely been selected. Indeed, those products that were most recently near the shopper prior to the shopper approaching the terminal are more likely to have been manually selected then those products that the shopper was near at some early point in time.

However, the terminal 18 that includes or is associated with the scales and upon which the information regarding the one or more products are identified, such as the one or more products having the greatest likelihood of having been manually selected, may be located elsewhere throughout the store, such as in conjunction with a point of sale system. In this instance, the shopper may select a number of products throughout the store and may approach the point of sale system immediately prior to their departure from the store. In conjunction with the determination of the price to be paid by the shopper for the products that have selected, the point of sale system may also include scales for weighing certain products that are not individually packaged or otherwise purchased in bulk. In this regard, the point of sale system may embody the terminal that includes or is associated with the scales such that information regarding the one or more products that were identified, such as the one or more products that were identified to have the greatest likelihood of having been manually selected by the shopper, may be presented for selection by the shopper at the point of sale in an efficient manner. In this embodiment, however, the apparatus 22, such as the processing circuitry 30, is configured to determine the likelihood that a respective product was manually selected based upon the comparison of the locations of the shopper to the location of the respective product without consideration of the elapsed time between the time at which the shopper was proximate the respective product and the time as which the shopper is proximate the terminal. In this regard, the shopper may have walked through the entire store after having manually selected a fruit or a vegetable prior to reaching the point of sale system such that the elapsed time from the time at which the shopper was proximate a respective product has less, if any, relationship to the likelihood that respective product was manually selected. However, the apparatus, such as the processing circuitry, may be configured in this example embodiment to take into account one or more other time-related quantities, which may affect the determined likelihood that a respective product was manually selected. As described above, for example, the longer the shopper stayed in the proximity of a product and/or the lower the speed of the shopper in proximity to the product, the apparatus, such as the processing circuitry, may determine the likelihood that the shopper manually selected the product to be greater.

Additionally, the apparatus 22, such as the processing circuitry 30, of an example embodiment may be configured to not simply include or exclude information regarding the elapsed time between the time at which shopper was proximate a respective product and the time at which the shopper is proximate the terminal at which the product is being weighed, but the apparatus, such as the processing circuitry, of other example embodiments may be configured to differently weight the contributions of the spatial and temporal determinations to the determination of the likelihood that a product was selected by the shopper. In this regard, the apparatus, such as the processing circuitry, of an example embodiment is configured to determine the likelihood that a product was selected based upon both the spatial determination of the locations of the shoppers in comparison to the location of a respective product and the temporal determination of the elapsed time between the time at which the shopper was proximate the respective product and the time at which the shopper is proximate the terminal at which the product is being weighed with the spatial and temporal determinations being differently weighted. In this example embodiment, the contribution based upon the elapsed time may be weighted more greatly in an instance in which the terminal is positioned proximate the products that are manually selected and in advance in the point of sale system than in an instance in which the terminal is associated with a point of sale system.

Although described above in conjunction with a single shopper, the method, apparatus 22 and computer program product of an example embodiment may be configured to identify one or more products that have been selected by any one of a group of shoppers who are paying for the products selected by any member of the group in the same transaction. In this regard, a shopper may be associated with one or more additional shoppers to form the group of shoppers. This association between the shoppers may be defined in any of various manners, such as by registering information regarding the mobile terminals carried by each of the shoppers of the group in conjunction with an account, such as a frequent shoppers account, maintained by the store or the apparatus. Additionally or alternatively, the association between shoppers may be defined based upon any similarities of the routes taken by the shoppers within the store, such as portions of the routes in which the shoppers walked together and/or points of intersections between the routes of the shoppers.

In this example embodiment, the apparatus 22, such as the processing circuitry 30, is configured to perform the comparison of block 44 by performing, for each of the plurality of products and for each of the shoppers, a comparison of one or more locations of a respective shopper relative to the location of the respective product including, in some embodiments, a determination as to the minimum distance between the locations of the shoppers of the group and the location of the respective product. In this example embodiment, the apparatus, such as the processing circuitry, is configured to determine the likelihood by determining, for each of the plurality of products, the likelihood that the respective product was manually selected based upon the comparison of the one or more locations of the respective shoppers relative to the location of the respective product, such as based upon the minimum distance of the shoppers of the group to the location of the respective product. Based on the likelihoods that respective products were manually selected, the apparatus, such as the processing circuitry, of this example embodiment is configured to identify one or more of the plurality of products that were selected by the group of shoppers. As such, even in an instance in which a plurality of shoppers collectively shop for products, the method, apparatus and computer program product of an example embodiment permits product(s) selected by the group of shoppers to be identified in an efficient and accurate manner.

As described above, FIG. 4 is a flowchart of an apparatus 22, method, and computer program product configured to identify a selected product based on location according to an example embodiment. It will be understood that each block of the flowchart, and combinations of blocks in the flowchart, may be implemented by various means, such as hardware, firmware, processing circuitry 30, and/or other devices associated with execution of software including one or more computer program instructions. For example, one or more of the procedures described above may be embodied by computer program instructions. In this regard, the computer program instructions which embody the procedures described above may be stored by the memory 32 of the apparatus and executed by the processing circuitry or the like. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for identifying a selected product based on location, the method comprising:
for each of a plurality of products, performing a comparison of one or more locations of a shopper relative to a location of a respective product;
for each of the plurality of products, determining, based upon the comparison of the one or more locations of the shopper relative to the location of the respective product, a likelihood that the respective product was manually selected; and
based on the likelihoods that respective products were manually selected, identifying one or more of the plurality of products.

2. A method according to claim 1, wherein determining the likelihood comprises determining the likelihood that the respective product was manually selected based also upon a time at which the location of the shopper was proximate the respective product.

3. A method according to claim 2, wherein determining the likelihood further comprises determining the likelihood that the respective product was manually selected based upon a difference between the time at which the location of the shopper was proximate the respective product and a time at which the shopper is proximate a terminal at which the respective product is to be identified.

4. A method according to claim 3, wherein the terminal comprises or is associated with scales configured to weigh the respective product.

5. A method according to claim 3, wherein determining the likelihood further comprises evaluating a probability function having an inverse relationship to the difference between the time at which the location of the shopper was proximate the respective product and the time at which the shopper is proximate the terminal at which the respective product is to be identified.

6. A method according to claim 3, wherein performing the comparison comprises determining, for each of the plurality of products, a minimum distance between the one or more locations of the shopper and the location of the respective product, wherein the method further comprises, for each of the plurality of products, determining a time at which the shopper was located at the minimum distance from the location of the respective product, and wherein determining the likelihood comprises determining the likelihood that the respective product was manually selected based upon the difference between the time at which the location of the shopper was located at the minimum distance from the location of the respective product and the time at which the shopper is proximate the terminal at which the respective product is to be identified.

7. A method according to claim 1, further comprising determining the one or more locations of the shopper utilizing an indoor positioning technique.

8. A method according to claim 1, wherein determining the likelihood comprises modifying the likelihood in a manner that is dependent upon a speed at which the shopper is walking proximate the location of the respective product.

9. A method according to claim 1, wherein determining the likelihood comprises modifying the likelihood in a manner that is dependent upon an amount of time expended by the shopper proximate the location of the respective product.

10. A method according to claim 1, further comprising causing presentation of information regarding the one or more of the products that were identified to facilitate selection by the shopper.

11. A method according to claim 10, wherein causing presentation of information comprises causing information regarding the one or more of the products that were identified to be displayed upon a terminal that comprises or is associated with scales configured to weigh the respective product.

12. A method according to claim 10, further comprising sorting the plurality of products based upon the likelihoods that respective products were manually selected, wherein causing presentation of information regarding the one or more of the products comprises causing presentation of information regarded two or more of the plurality of products with the information ordered pursuant to the sorting.

13. A method according to claim 1, wherein the shopper is associated with one or more additional shoppers, wherein performing the comparison comprises performing, for each of the plurality of products and for each of the shoppers, the comparison of one or more locations of a respective shopper relative to the location of the respective product, and wherein determining the likelihood comprises determining, for each of the plurality of products, the likelihood that the respective product was manually selected based upon the comparison of the one or more locations of the respective shoppers relative to the location of the respective product.

14. An apparatus configured to identify a selected product based on location, the apparatus comprising processing circuitry and at least one memory storing computer program code, the at least one memory and the computer program code configured to, with the processing circuitry, cause the apparatus to at least:
for each of a plurality of products, perform a comparison of one or more locations of a shopper relative to a location of a respective product;
for each of the plurality of products, determine, based upon the comparison of the one or more locations of the shopper relative to the location of the respective product, a likelihood that the respective product was manually selected; and
based on the likelihoods that respective products were manually selected, identify one or more of the plurality of products.

15. An apparatus according to claim 14, wherein the at least one memory and the computer program code are configured to, with the processing circuitry, cause the apparatus to determine the likelihood by determining the likelihood that the respective product was manually selected based also upon a time at which the location of the shopper was proximate the respective product.

16. An apparatus according to claim 15, wherein the at least one memory and the computer program code are configured to, with the processing circuitry, cause the apparatus to determine the likelihood by determining the likelihood that the respective product was manually selected based upon a difference between the time at which the location of the shopper was proximate the respective product and a time at which the shopper is proximate a terminal at which the respective product is to be identified.

17. An apparatus according to claim 16, wherein the at least one memory and the computer program code are configured to, with the processing circuitry, cause the apparatus to determine the likelihood by evaluating a probability function having an inverse relationship to the difference between the time at which the location of the shopper was proximate the respective product and the time at which the shopper is proximate the terminal at which the respective product is to be identified.

18. An apparatus according to claim 16, wherein the at least one memory and the computer program code are configured to, with the processing circuitry, cause the apparatus, to perform the comparison by determining, for each of the plurality of products, a minimum distance between the one or more locations of the shopper and the location of the respective product for each of the plurality of products, wherein the at least one memory and the computer program code are further configured to, with the processing circuitry, cause the apparatus, to determine a time at which the shopper was located at the minimum distance from the location of the respective product, wherein the at least one memory and the computer program code are configured to, with the processing circuitry, cause the apparatus to determine the likelihood by determining the likelihood that the respective product was manually selected based upon the difference between the time at which the location of the shopper was located at the minimum distance from the location of the respective product and the time at which the shopper is proximate the terminal at which the respective product is to be identified.

19. An apparatus according to claim 14, wherein the at least one memory and the computer program code are further configured to, with the processing circuitry, cause the apparatus to:
sort the plurality of products based upon the likelihoods that respective products were manually selected; and
cause presentation of information regarding two or more of the products that were identified with the information ordered pursuant to the sorting to facilitate selection by the shopper.

20. A computer program product configured to identify a selected product based on location, the computer program product comprising at least one non-transitory computer-readable storage medium having computer-executable program code instructions stored therein, the computer-executable program code instructions comprising program code instructions configured to, when executed by an apparatus, cause the apparatus to:
for each of a plurality of products, perform a comparison of one or more locations of a shopper relative to a location of a respective product;
for each of the plurality of products, determine, based upon the comparison of the one or more locations of the shopper relative to the location of the respective product, a likelihood that the respective product was manually selected; and
based on the likelihoods that respective products were manually selected, identify one or more of the plurality of products.
